(19) United States
(12) Patent Application Publication
(10) Pub. No.: US 2020/0392767 A1
(43) Pub. Date: Dec. 17, 2020

(54) FUNKTIONSKOMPONENTE EINER KRAFTFAHRZEUGSCHLOSSANORDNUNG

(71) Applicant: Brose Schließsysteme GmbH & Co. Kommanditgesellschaft, Wuppertal, Wuppertal (DE)

(72) Inventors: Markus KOTHE, Velbert (DE); Sebastian KNOCHE, Hagen (DE)

(73) Assignee: Brose Schließsysteme GmbH & Co. Kommanditgesellschaft, Wuppertal, Wuppertal (DE)

(21) Appl. No.: 16/885,656

(22) Filed: May 28, 2020

(30) Foreign Application Priority Data
May 29, 2019 (DE) 10 2019 114 540.6

(51) Int. Cl. E05B 81/74; E05B 79/20; E05B 81/06; E05B 81/16; E05B 81/30; E05B 85/26

(52) U.S. Cl. CPC E05B 81/74; E05B 79/20; E05B 81/06; E05B 85/243; E05B 81/30; E05B 85/26; E05B 81/16

(57) ABSTRACT

A functional component of a motor vehicle lock arrangement, the functional component has a drive arrangement with a motor and an adjustment element coupled to the drive arrangement. The adjustment element can be deflected out of a predetermined engaged position in a deflecting movement, and the deflected adjustment element can be reset into the engaged position in a resetting movement. The deflecting movement can be produced by means of the drive arrangement and the drive motor operates in the motor mode, and the resetting movement is spring-driven and the drive motor operates in the generator mode. The functional component may include a monitoring unit which determines the position of the adjustment element reached in the resetting movement from the motor voltage of the drive motor in accordance with a monitoring rule.

### CROSS-REFERENCE TO RELATED APPLICATIONS

This application claims the benefit of German Patent Application No. DE 10 2019 114 540.6 filed May 29, 2020, the disclosure of which is hereby incorporated in its entirety by reference herein.

### TECHNICAL FIELD

The present disclosure relates to a functional component of a motor vehicle lock arrangement and a method for operating same.

### BACKGROUND

A motor vehicle lock arrangement may include a functional component of “motor vehicle lock” and optionally further functional components, such as an external motorized closing unit or an external motorized opening unit for the motor vehicle lock. The motor vehicle lock may be configured to lock any closure element of the motor vehicle. These include tailgates, rear covers, front hoods, side doors or the like. All of the closure elements may be configured in the manner of swing doors or in the manner of sliding doors.

### SUMMARY

According to at least one embodiment, an adjustment element, such as a catch may be deflected out of a predetermined engaged position in a deflecting movement, and the deflected adjustment element may be reset to move to the engaged position in a resetting movement. As an example, the deflecting movement may be produced by means of the drive arrangement, and the drive motor then operates in the motor mode, while the resetting movement may be provided in a spring-driven manner, and the drive motor operates in the generator mode.

In one or more embodiments, adjustment of the adjustment element in the resetting movement may be derived from the motor voltage of the drive motor. This is because the drive motor operates in the generator mode during the resetting movement. In the case of a direct current motor, this means that the drive motor has waves, generally halfwaves, in the motor voltage, which provide information about the extent of the rotation of the motor shaft. Alternatively, a conclusion may be drawn regarding the adjustment speed of the motor shaft and therefore of the adjustment element via the magnitude of the motor voltage. From integration over time, a conclusion may then be drawn regarding the position of the adjustment element. In each case, the position of the adjustment element that has actually been reached in the resetting movement is determined from the motor voltage of the drive motor.

As an example, the functional component may include a monitoring unit that may determine the position of the adjustment element that has actually been reached in the resetting movement from the motor voltage of the drive motor in accordance with a monitoring rule.

For the situation in which the functional component according to the proposal is a motor vehicle lock, an apparent locking of the motor vehicle lock attributed to an incomplete resetting movement of the catch may be identified and reduced by suitable connection measures. The solution according to the proposal may be used without an additional sensor being required.

Simply for clarification, it should be pointed out that the functional component here is claimed as such, i.e. furthermore without the motor vehicle lock arrangement.

As an example, the reaction of the monitoring unit to the identification of an incomplete resetting movement are the subject matter of claim 2. In the simplest case, a corresponding warning message may be issued to the vehicle operator within the scope of an alarm routine.

The determination of the position of the adjustment element that has actually been reached in the resetting movement may be undertaken with respect to a reference position such as the position of the adjustment element that has actually been reached in the deflecting movement. For example, the deflecting movement may be defined by an end stop or an end switch, and therefore the reference position of the adjustment element is reached in a correspondingly reproducible manner.

In one or more embodiments. The ripple of the motor voltage and the magnitude of the motor voltage may each supply a starting point for a solid monitoring of the position of the adjustment element that has actually been reached in the resetting movement. This applies in particular if the drive motor is a direct current motor.

In one or more embodiments, a monitoring rule, such as the relationship represented by the monitoring rule between the motor voltage and the position of the adjustment element that has actually been reached in the resetting movement, depends on certain ambient conditions, such as the ambient temperature.

The monitoring rule may be based on certain conditions and capable of learning. In one or more embodiments, the monitoring rule, such as the above relationship represented by the monitoring rule is then learned such that a precise determination of the position of the adjustment element is ensured in the resetting movement. The starting point here is that the deflecting movement and/or the resetting movement is/are mechanically fixedly predetermined.

In one or more embodiments, the functional component may be a motor vehicle lock of the motor vehicle lock arrangement. The catch of the motor vehicle lock is the adjustment element. It may therefore be checked in an elegant manner with the solution according to the proposal whether the catch has or has not reached its completely engaged position.

In one or more embodiments, the drive arrangement may include a flexible traction means. As an example, the flexible traction means may be wound on the drive shaft of the drive motor. The resetting movement of the adjustment element may be associated with an unwinding of the flexible traction means and therefore with driving back of the drive motor, and therefore the monitoring function according to the proposal may be used without further structural measures.

According to a yet another embodiment, a method of operating a functional component may be provided.

As an example, the position of the adjustment element that has actually been reached in the resetting movement may be determined by means of a monitoring unit of the motor voltage of the drive motor in accordance with a monitoring rule. In this respect, reference should be made to all of the statements regarding the manner of operation of the functional component according to the proposal.

### BRIEF DESCRIPTION OF THE DRAWINGS

The invention will be explained in more detail below with reference to a drawing which merely constitutes an exemplary embodiment. In the drawing

FIG. 1 shows a functional component according to the proposal that is considered as a motor vehicle lock with an adjustment element which is in the engaged position and is configured at a catch, and

FIG. 2 shows the functional component according to FIG. 1 during the resetting movement of the adjustment element configured as a catch.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known functional component which is configured as a motor vehicle lock (EP 1 536 090 A2) and on which the present disclosure is based is equipped with the conventional locking elements—“lock latch” and “catch”. The motor vehicle lock has a drive arrangement with an electric drive motor for lifting out the catch. The drive arrangement acts via a drive cable on the catch by the drive cable being wound up on the motor shaft of the drive motor. After the catch has been lifted out by the drive cable, the catch spring drives the entire drive train back, which is associated with the drive cable unwinding from the motor shaft.

There is a challenge in the case of the known motor vehicle lock to detect an incomplete resetting movement. In such a case, the catch, for example due to mechanical sluggishness, does not reach its original engaged position, and the correct engagement between the lock latch and the catch is correspondingly not present. In order to detect such a lock state, a corresponding catch sensor is provided in the known motor vehicle lock.

The sensorless monitoring of drive arrangements of a motor vehicle lock for adjustment element movements that are produced in a motorized manner by a drive arrangement is basically known (DE 100 21 186 A1). Use is made here of what is referred to as the current wave count or what is referred to as the ripple count method. However, this can be used only if a corresponding drive current also closes down, which is generally not the case especially during the resetting movement in the foreground here.

The present disclosure is based on the problem of configuring and developing the known functional component of a motor vehicle lock arrangement in such a manner that the reaching of the engaged position of the adjustment element in the resetting movement can be monitored with little outlay.

The illustrated functional component 1 is configured as a motor vehicle lock of a motor vehicle lock arrangement 2. The functional component 1, here the motor vehicle lock, can be assigned to any closure element of a motor vehicle. In this respect, reference should be made to the introductory part of the description.

The functional component 1, here the motor vehicle lock, has a drive arrangement 3 with an electric drive motor 4 and has an adjustment element 5 which is coupled or can be coupled to the drive arrangement 3. The adjustment element 5 is configured here and preferably as a catch, as will also be explained.

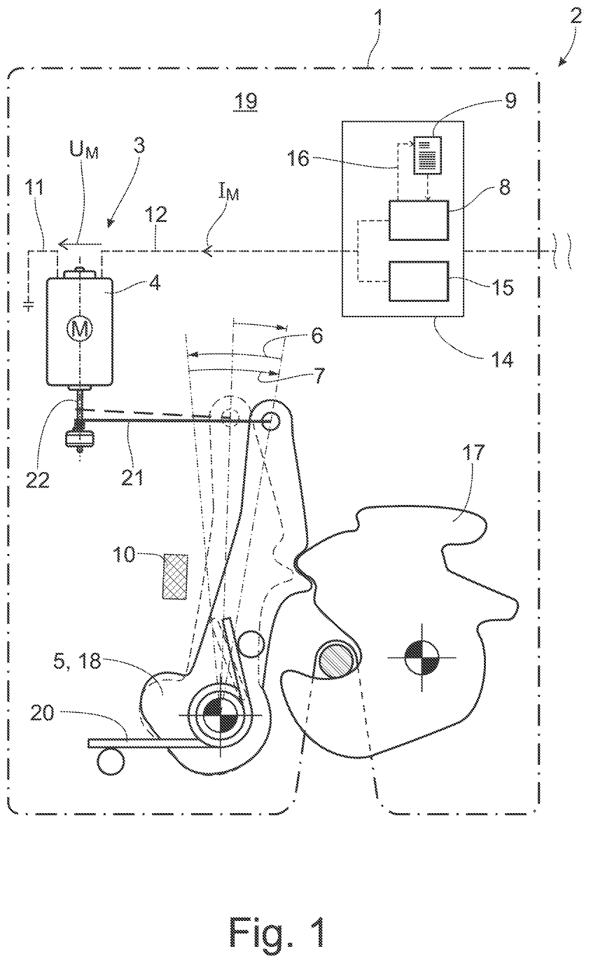

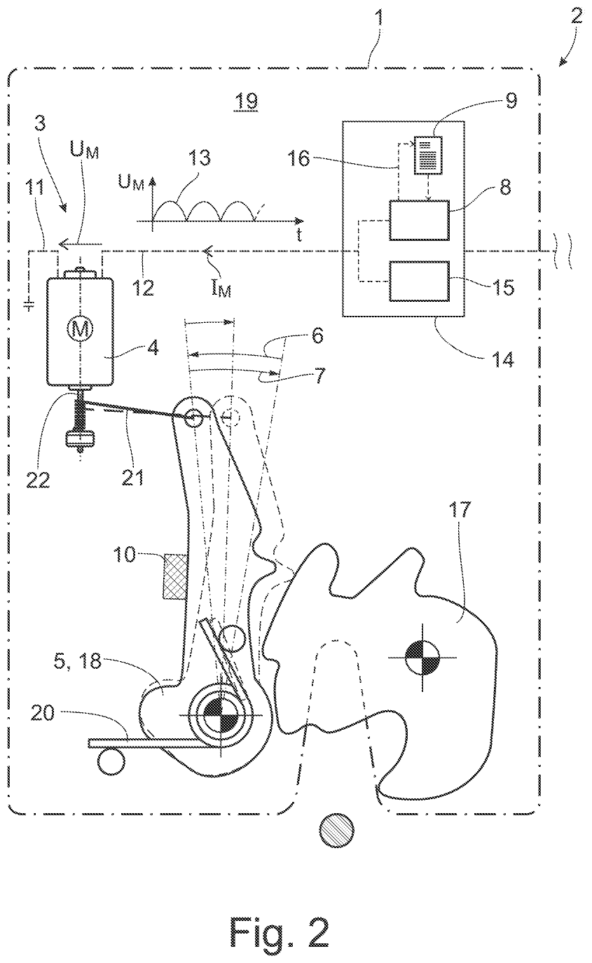

The adjustment element 5 can be deflected out of a predetermined engaged position (FIG. 1) in a deflecting movement 6, and the deflected adjustment element 5 (FIG. 2) can be reset into the engaged position in a resetting movement 7.

It is apparent from an overall view of FIG. 1 and FIG. 2 that the deflecting movement 6 can be produced by means of the drive arrangement 3, and the drive motor 4 then operates in the motor mode. It is furthermore apparent from this overall view that the resetting movement 7 is, here and may be exclusively, spring-driven, and the drive motor 4 then operates in the generator mode.

It is now essential that the functional component 1, here the motor vehicle lock, has a monitoring unit 8 which determines the position of the adjustment element 5 that has actually been reached in the resetting movement 7 from the motor voltage U_{M} of the drive motor 4 in accordance with a monitoring rule 9.

A starting point according to the proposal is therefore that the adjustment element 5 can be adjusted in the resetting movement into the predetermined engaged position which is illustrated by a solid line in FIG. 1. However, it has also been identified according to the proposal that the resetting movement can also be incomplete in such a manner that an erroneous position upstream of the predetermined engaged position is reached rather than the predetermined engaged position. This may be attributed, for example, to soiling, icing or the like, which leads to the spring force which has yet to be explained and which acts on the adjustment element 5 not being of a sufficient magnitude to overcome such an obstruction.

A predetermined deviation of the position of the adjustment element 5 that has actually been reached in the resetting movement 7 from the engaged position may be, using the example of the functional component 1 configured as a motor vehicle lock, that there is an apparent locking, i.e. an incomplete locking. This is illustrated by a dashed line in FIG. 1. As indicated above, this apparent locking is attributed to the fact that the resetting movement 7 is an incomplete resetting movement. Upon such a deviation being detected, the monitoring unit 8 carries out an alarm routine which carries out a corresponding measure. In a first variant, it is provided that the alarm routine issues a warning message to the vehicle operator. Alternatively or additionally, it can be provided that the alarm routine locks the continued operation of the drive arrangement 3 in order to remove further risks.

The monitoring unit 8 determines the position of the adjustment element 5 that has actually been reached in the resetting movement 7 with respect to a reference position of the adjustment element 5 in accordance with the monitoring rule 9. Here as an example, the reference position in accordance with the monitoring rule 9 is the position of the adjustment element 5 that has actually been reached in the deflecting movement and that is illustrated in FIG. 2. The reference position may be defined in the above context by the end stop 10.

A robust determination of the position of the adjustment element 5 that has actually been reached in the resetting movement 7 arises by the fact that the position of the adjustment element 5 is determined from the profile of the motor voltage U_{M} in accordance with the monitoring rule 9. This is illustrated in FIG. 2. The starting point here is that, during the resetting movement 7, the supply connections 11, 12 of the drive motor 4 are free from a supply voltage. As an example, in the configuration of the drive motor, a sequence of halfwaves 13 then arises in the motor voltage U_{M}, and the term “halfwave” can be interpreted widely here.

It can be gathered from the illustration according to FIG. 2 that a conclusion can be drawn regarding the distance covered by the drive motor 4 and therefore by the adjustment element 5 from the number of halfwaves 13. A counting mechanism merely has to be provided here in the monitoring unit 8.

Alternatively, it can be provided that the monitoring unit 8 determines the position of the adjustment element 5 that has actually been reached in the resetting movement 7 from the magnitude of the motor voltage U_{M} in accordance with the monitoring rule 9. The term “magnitude of the motor voltage” can represent the maximum of the halfwaves 13 illustrated in FIG. 2, an average value via the halfwaves 13 illustrated in FIG. 2, or the like. Irrespective of the specific definition, the magnitude of the motor voltage U_{M} is proportional to the adjustment speed of the drive motor 4 and therefore to the adjustment speed of the adjustment element 5. Accordingly, it may be provided that the monitoring unit 8 determines the adjustment speed of the adjustment element 5 that actually prevails in the resetting movement 7 from the magnitude of the motor voltage U_{M} in accordance with the monitoring rule 9 and determines the position of the adjustment element 5 that has actually been reached, with respect to the above reference position, from the determined, actually prevailing adjustment speed of the adjustment element 5. The position of the adjustment element 5 may arise by integration of the adjustment speed and/or of the motor voltage U_{M} over time. This variant can be used insofar as an above-discussed counting mechanism for the halfwaves in the motor voltage U_{M} is not required. However, this determination is dependent on ambient conditions, such as the ambient temperature, which requires additional compensation measures. This will be explained further below.

In one or more embodiments, the drive motor 4 is configured as a direct current motor may be separately excited. Other types of electric machines can be used here. These include in particular brushless direct current motors.

FIG. 1 shows that the monitoring unit 8 is part of a control unit 14 which, in addition to the monitoring unit 8, has a driver unit 15 for supplying the drive motor 4 with electric driving power. The control unit 14 ensures that the drive motor 4 is free of a supply voltage, such as from the driver unit 15, during the resetting movement 7. The supply connections 11, 12 of the drive motor 4 may not be coupled electrically to one another during the resetting movement 7, are not short-circuited, in order to avoid a braking action in the manner of short-circuit braking.

In very general terms, the above monitoring rule 9 represents the relationship between the motor voltage U_{M} and the position of the adjustment element 5 that has actually been reached in the resetting movement 7. The above alternative mentioned second here involves the relationship between the motor voltage U_{M} and the adjustment speed of the drive motor 4, and therefore of the adjustment element 5, that actually prevails in the resetting movement 7. As an example, this relationship is dependent on ambient conditions, such as an ambient temperature. In one or more embodiments, the monitoring unit 8 determines the ambient temperature and adapts the monitoring rule 9 to the ambient temperature. The adaptation is indicated in the drawing by reference sign 16. In the simplest case, the ambient temperature can be determined by the monitoring unit 8 via the CAN bus of the motor vehicle, since it is assumed that, in modern motor vehicles, a corresponding temperature sensor is accessible via the CAN bus.

The monitoring rule 9 can be adapted, for example, on the basis of a physical motor model of the drive motor 4. However, it is also conceivable that the monitoring unit 8 is configured for this purpose to be capable of learning within a certain extent. For this purpose, it may be provided that the monitoring unit 8 determines the ambient temperature from the motor current I_{M} in a reference run of the adjustment element 5. In the simplest case, the known temperature dependency of the ohmic resistance of the motor winding of the drive motor 4 can be used here.

Alternatively or additionally, it can be provided that the relationship between the motor voltage U_{M} and the position of the adjustment element 5 that has actually been reached in the resetting movement 7, such as the adjustment speed of the adjustment element 5 that actually prevails in the resetting movement 7, is determined from the motor current I_{M} in a reference run. The reference run here may be the deflecting movement of the adjustment element 5, i.e. the movement of the adjustment element 5 produced in a motorized manner by the drive arrangement 3. Alternatively or additionally, the reference run can also be the resetting movement of the adjustment element 5. If a physical motor model of the drive motor 4 is at the basis of the above relationship, a parametrization of the motor model can be determined from such a reference run and the determination of the resulting motor current I_{M}, in particular in the first-mentioned case, the parameterization then being able to be at the basis of the determination of the position of the adjustment element 5 that has actually been reached in the resetting movement.

Alternatively or additionally, it can be provided that the monitoring unit 8 determines the motor voltage U_{M} of the drive motor 4 in a reference run and produces or adapts the monitoring rule depending on the determined motor voltage U_{M}. As an example, the monitoring unit 8 determines the relationship between the motor voltage U_{M} and the position that has actually been reached in the resetting movement 7, in particular the adjustment speed of the adjustment element 5 that actually prevails in the resetting movement 7, from the motor voltage U_{M}, in particular from the voltage profile. In the simplest case, a characteristic voltage profile can be stored in the monitoring unit 8, and a conversion factor for determining the position of the adjustment element 5 that has actually be reached that may be determined from the deviation of the voltage profile determined in the reference run from the characteristic voltage profile. However, the conversion factor can also arise simply from the number of the above halfwaves in the motor voltage U_{M}. A system for determining the conversion factor can be determined, for example, in a series of tests. As discussed above, the starting point may be that the deflecting movement and/or the resetting movement is/are fixedly predetermined mechanically, for example by corresponding blocking stops.

As discussed above, the functional component 1 may be a motor vehicle lock of the motor vehicle lock arrangement, as shown in the drawing. The functional component 1 may include the locking elements lock latch 17 and catch 18, which interact with each other in a manner which is customary per se.

Furthermore, the motor vehicle lock may include a lock housing 19, and the monitoring unit 8, as an example, is arranged in the lock housing 19. In principle, it can also be provided that the entire control unit 14 is arranged in the lock housing 19. Furthermore, it is conceivable that the monitoring unit 8 and optionally the entire control unit 14 is or are furthermore arranged outside the lock housing and spatially separately from the motor vehicle lock.

As an example, the adjustment element 5 is furthermore the catch 18 of the motor vehicle lock, and the deflecting movement 6 is lifting out of the catch 18 within the scope of a motorized opening function. The catch 18 here may be assigned a catch spring 20 which ensures the spring-driven resetting movement 7 indicated above.

Alternatively and not illustrated, it can be provided that the adjustment element 5 is the lock latch 17 of the motor vehicle lock, and the deflecting movement 6 is a locking movement of the lock latch 17 within the scope of a motorized closing function.

Furthermore alternatively, it can be provided that the adjustment element 5 is a functional lever for setting a lock state. The functional lever includes, for example, a central locking lever, a theft protection lever or a child safety lock lever. Other use fields for the solution according to the proposal are conceivable.

It emerges from the above explanation that the drive arrangement 3 is considered in the manner such that it can be driven back, and the drive arrangement 3 is coupled to the adjustment element 5 in such a manner that the spring-driven resetting movement of the adjustment element 5 is associated with a driving back of the drive motor 4. This corresponds to the manner of operation of the exemplary embodiment which is illustrated in the drawing. The drive arrangement 3 here has a flexible traction means 21 which directly or indirectly connects the drive motor 4 to the adjustment element 5 and can be wound up by the drive motor 4 in order to produce the deflecting movement 6. The flexible traction means 21 can be, for example, a cable, a belt, a chain or the like. The flexible traction means 21 can be configured from a plastics material, from a metal material or the like.

As an example, the flexible traction means 21 can be wound up on a drive shaft 22, such as on the motor shaft of the drive motor 4, by means of the drive motor 4. It can be gathered in the drawing that the spring-driven movement back out of the situation shown in FIG. 2 leads to an unwinding of the flexible traction means 21 from the drive shaft 22, as a result of which a corresponding motor voltage U_{M} is produced at the supply connections 11, 12 of the drive motor 4.

According to a further teaching which obtains independent importance, a method for operating a functional component 1 according to the proposal of a motor vehicle lock arrangement 2 is claimed as such.

According to the method according to the proposal, the functional component 1 has a drive arrangement 3 with an electric drive motor 4 and an adjustment element 5 which is coupled or can be coupled to the drive arrangement 3. The adjustment element 5 is deflected out of a predetermined engaged position in a deflecting movement 6, and the deflected adjustment element 5 is reset into the engaged position in a resetting movement 7. Furthermore, the deflecting movement 6 is produced by means of the drive arrangement 3 while the resetting movement is spring-driven.

An essential feature of the method according to the proposal is that the position of the adjustment element 5 that has actually been reached in the resetting movement 7 is determined from the motor voltage U_{M} of the drive motor 4 by means of a monitoring unit 8 in accordance with a monitoring rule 9. In this respect, reference should be made to all of the statements regarding the manner of operation of the functional component 1 according to the proposal.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

1 functional component

2 motor vehicle lock arrangement

3 drive arrangement

4 drive motor

5 adjustment element

6 deflecting movement

7 spring-driven resetting movement

8 monitoring unit

9 monitoring rule

10 end stop

11 supply connections

12 supply connections

13 halfwaves

14 control unit

15 driver unit

16 reference sign

17 lock latch

18 catch

19 lock housing

20 catch spring

21 flexible traction means

22 drive shaft

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A motor vehicle lock arrangement comprising:
a drive arrangement provided with a motor; and
an adjustment element coupled to the drive arrangement and configured to be deflected by a deflecting movement, generated by the motor, from an engaged position to a disengaged position and configured to be reset by a resetting movement, generated by a spring, from the disengaged position to the engaged position; and
a monitoring unit programmed with a monitoring rule and configured to, determine a position reached by the adjustment element during the resetting movement, responsive to comparing a motor voltage of the drive motor with the monitoring rule.

2. The motor vehicle lock arrangement of claim 1, wherein the monitoring unit is configured to, responsive to the position of the adjustment element deviating, from the engaged position.

3. The motor vehicle lock arrangement of claim 1, wherein the monitoring unit is configured to determines the position of the adjustment element with respect to a reference position, and wherein, the reference position is a position of the adjustment element reached when the adjustment element is moved by the deflecting movement.

4. The motor vehicle lock arrangement of claim 1, wherein the monitoring unit is configured to determine the position of the adjustment element based on a profile of the motor voltage including a number of halfwaves of the motor voltage.

5. The motor vehicle lock arrangement of claim 1, wherein the monitoring unit is further configured to determines an adjustment speed of the adjustment element moved by the resetting movement based on a magnitude of the motor voltage compared with the monitoring rule.

6. The motor vehicle lock arrangement of claim 1, wherein the drive motor is a direct current motor.

7. The motor vehicle lock arrangement of claim 5, wherein the monitoring unit is further configured to, responsive to determining an ambient temperature, alter the monitoring rule based on the ambient temperature.

8. The motor vehicle lock arrangement of claim 7, wherein the monitoring unit is configured to determines the ambient temperature based on a motor current of the motor as the motor during a reference run of the adjustment element.

9. The motor vehicle lock arrangement of claim 8, wherein the monitoring unit is further configured to alter the monitoring rule based on a motor voltage or an adjustment speed of the adjustment element of the motor during the reference run.

10. The motor vehicle lock arrangement of claim 8, wherein the reference run is the deflecting movement of the adjustment element and/or the resetting movement of the adjustment element.

11. The motor vehicle lock arrangement of claim 1, further comprising:
a motor vehicle lock including a lock latch and a catch, and a lock housing and wherein the monitoring unit disposed in the lock housing.

12. The motor vehicle lock arrangement of claim 11, wherein the adjustment element is the catch.

13. The motor vehicle lock arrangement of claim 11, wherein the adjustment element is the lock latch.

14. The motor vehicle lock arrangement of claim 1, wherein the drive arrangement includes a flexible traction means directly or indirectly connected to the motor and configured to be wound up by the motor to produce the deflecting movement.

15. The motor vehicle lock arrangement of claim 14, wherein the motor includes a motor shaft extending from the motor and the flexible traction means is configured to be wound up on the motor shaft.

16. A method of operating a motor vehicle lock arrangement including a drive arrangement, provided with a motor, and an adjustment element coupled to the drive arrangement, the method comprising:
deflecting the adjustment element from an engaged position to a disengaged position by operating the motor in a motor mode; and
resetting the adjustment element from the disengaged position to the engaged position by a spring biasing the adjustment element while the motor operates in a generator mode; and,
determining, by a monitoring unit, whether the adjustment element reaches a predetermined position during the resetting step, wherein the determining step includes comparing a motor voltage of the motor with a monitoring rule.

17. The motor vehicle lock arrangement of claim 2, wherein the alarm routine issues a warning message to a vehicle operator.

18. The motor vehicle lock arrangement of claim 2, wherein the alarm routine blocks continued operation of the drive arrangement.

19. A motor vehicle lock arrangement comprising:
a latch housing;
a motor including a drive shaft and disposed within the housing;
a lock catch configured to engage and disengage a striker;
a catch configured to move between an engaged position and a disengaged position, wherein when the catch is in the engaged position, the catch engages the lock catch and when the catch is in the disengaged position, the catch is disengaged position, the catch is disengaged from the lock catch;
a cable operatively coupled between the drive shaft and the catch, wherein as the motor actuates the drive shaft rotates pulling the cable and moves the catch from the engaged position and the disengaged position;
a spring configured to bias the spring from the disengaged position to the engaged position; and
a monitoring unit configured to, responsive to a motor voltage exceeding a predetermined threshold, determine if the adjustment element reaches a predetermined position as the catch moves from the disengaged position to the engaged position.

20. The motor vehicle lock arrangement of claim 19, wherein the monitoring unit is configured to, responsive to receiving an ambient temperature from a temperature sensor, alter the predetermined threshold.
